(19) United States
(12) Patent Application Publication
(10) Pub. No.: US 2012/0011555 A1
(43) Pub. Date: Jan. 12, 2012

(54) Watch new released movies online synchronizing with new released movies shown in cinemas

(75) Inventor: Qiuhang Qian, Duluth, GA (US)

(73) Assignee: Qiuhang Richard Qian, Doraville, GA (US)

(21) Appl. No.: 12/804,136

(22) Filed: Aug. 18, 2010

Related U.S. Application Data
(60) Provisional application No. 61/363,251, filed on Jul. 11, 2010.

(51) Int. Cl. H04N 7/173

(52) U.S. Cl. 725/109

(57) ABSTRACT

A new way of watching new released movies at home or on the road through personal computers and TV is invented. With this invention people can choose and watch any new released movie in any cinema in the city, metro area, and other cities in the state or even out of the state.

Automated procedures & packages stored on the server engine initiate and run queries down through the data levels of the cinema master forecasts in the country. The queries generate two different forecast schedule reports. The first type of forecast schedule report is for updating the GUI interfaces for all the cinemas in the country. The second type of forecast schedule report is for updating the movie schedules for the screen pool. If the first type changes, the second type changes too. They are supported both by the technical and administrative staff.

The Internet has continued to expand, although it has some setbacks for the past few years. It will grow and touch every sector in every industry where currently has not been explored. It will grow more and more mature in the future and will finally form a well-established internet industry. The internet industry has provided commercial and non-commercial services for the business, people and the society. It will continue to do better and better.

It is known that old movies can be downloaded and people can watch them online. It is also known that there are companies offering to watch old movies on TV at home through subscription. Watching new released movies online synchronizing with the new released movies shown in cinemas is a brand new concept. People can select a new movie that is exactly shown in a local cinema and watch it at home or on the road.

The customer logs onto the internet and accesses to the website where the customer will choose an area, a cinema and select a movie. The customer needs to create an account either after logging in the website or when purchasing a ticket. An area refers to a state, a metro area, or a city. To access to a cinema in a state, a metro area or a city, the customer can either search or walk through the web pages where the cinemas will be listed. Once it is done, the front picture of the cinema shows on the screen. The picture will look much like the real one with 3D simulation. The customer clicks the picture of the cinema and it will show all the movie posters. The movie showtimes and prices are listed under the posters. The customer selects a movie, how many people to watch, movie showtime and purchases the ticket(s). When purchasing the ticket(s), authentication is required. If the customer doesn't have an account, he or she needs to create one. If the customer has an account, he or she can purchases the ticket(s). After the payment is made online, it is ready to watch a movie when movie time begins. The time to watch a new movie online is exactly the same time that is shown in the cinema. They synchronize.

Currently there are 2115 cities with population over 20,000 and 5942 theaters in the US including about 381 driving-in theaters. It is reported that there were 1470 million attendances and 173 million people went to the movie in 2007. The average price to watch a movie in 2010 is $7.95. The revenue of the industry passed $10 billion in 2009.

The non-provisional patent application is written for protecting not only the idea which is “Watch new released movies online synchronizing with the new released movies shown in cinemas” but also describes how the platform is technically created. The claim listed above and below is exactly the same as the provisional filing. It contains no new matter.

### TECHNICAL FIELD

The present invention relates to website and computer server systems that are capable of running and support web application and programs. More particularly, the present invention relates to the systems that are capable of running web applications and provide to watch new released movies online.

### BACKGROUND OF THE INVENTION

Going to the movies has long been a staple American pastime, but this traditional night out has come under pressure in recent years. The number of moviegoers has been growing slowly, if at all, reflecting the rising popularity of alternatives such as DVDs (especially with the advent of high definition formats), television, and on-demand Internet services. While some of the larger chains of traditional cinemas have posted slightly increased sales over the past few years, the movie theater business is slow-growing at best.

Film studios cite a rise in piracy as the reason for their increasing emphasis on non-theatrical distribution methods. Studios make much higher margins on DVD sales and royalties from pay-per-view providers, giving them an incentive to pursue these distribution vehicles more aggressively. Barry Meyer, the chairman and CEO of Warner Bros. Entertainment was quoted as saying that, in the future, “your premiere will be in Wal-Mart.”Some data suggest that the movie industry is heading in exactly this direction: away from the traditional release timeline and more toward a simultaneous release of movies in theaters, on DVD, and on cable television. Film studios would benefit from the higher margins of the alternate distribution channels, as well as save on advertising expenses. Movie theaters, however, are staunchly opposed to this movement, citing the irreplaceable experience of catching a matinee or going on a late-night movie date as reasons why theaters cannot be replaced by DVDs and movies on television. While this may be true, film studios, which provide cinemas with the movies they need to attract customers, have a growing reason to pursue higher-margin distribution methods.

The Motion Picture Association of America, Inc. (MPAA) released its annual Theatrical Market Statistics Report for 2009. The report shows that global box office receipts reached an all time high of $29.9 billion, an increase of 7.6% over 2008 and almost 30% from 2005. The U.S./Canada market reached $10.6 billion, an increase of more than 10%, and International receipts increased 6.3% to $19.3 billion in 2009. Globally, the U.S. and Canada made up 35% followed by EMEA (33%), Asia Pacific (26%) and Latin America (6%).

The 3D market gave the U.S./Canada box office a boost accounting for 11% of the total compared to just 2% in 2008. With 20 films released in 3D compared to just eight in 2008, higher value entertainment contributed significantly to box office revenues.

“While the motion picture industry continues to face tremendous challenges elsewhere in our business, we're reminded again this year that the cinema is the heart and soul of our industry and it is thriving,” said Bob Pisano, President and Interim CEO of the MPAA.

Ticket sales in the U.S. and Canada rose more than 5.5% from 2008, the first admissions increase in two years. Per capita ticket purchases in the U.S. and Canada also increased 4.6% to 4.3 tickets per person, the first significant increase since 2002. Sales were fueled by repeated visits to the cinema by frequent moviegoers—those who go to the movies once a month or more and who make up only 10% of the population—who bought half of all tickets sold in 2009.

“Four straight years of box office growth—the last three each setting a new record—show the enormous appetite audiences continue to have for great and entertaining movies in the best way to enjoy them—on a big screen with a big crowd,” said John Fithian, President and CEO of the National Association of Theatre Owners.

At the end of 2009 there were more than 16,000 digital cinema screens worldwide, up 86% from the end of 2008, a net gain of more than 7,000 screens. The fastest growing sector of digital screens is 3D. The number of digital 3D screens worldwide more than tripled in 2009, reaching 8,989, or about 6% of screens in the world.

“Digital technology is the foundation on which 3D has been built. Together, digital presentation and 3D hold the promise of a dramatic game change in moviemaking and movie-going. The global film audience is voting with its feet, and those feet are planted firmly in the direction of local cinemas that have the latest technology,” said Pisano.

While box office revenues and admissions surged, films produced by U.S. production companies declined over the past three years. In 2009, the number of U.S. produced films released in domestic theaters decreased 12%, the first decline since 2003. The decline is attributable in significant part to labor issues affecting the industry in 2007-08, the recession and the challenges to investment recovery due to rampant content theft, and the decline in DVD sales.

Right now watching new movies involves going to a cinema. This model is facing headwinds because it takes more effort to drive to a cinema, buy ticket(s) and spending another two hours in the cinema. Watching new released movies at home, on the road synchronizing with the new released movies shown in cinemas will create a brand new watching movie experience. People who watch new movies online can check any new movie showtimes. They don't need to leave home. They don't need to worry about the weather whether it is summer or winter, rain or not. They can watch new movies with family members with lots of joy. They can do anything during the movie time without any limitation.

### BRIEF DESCRIPTION OF THE DRAWINGS

FIG. 1 is a functional diagram block illustrating how the business process flows.

FIG. 2 is a logical process diagram block illustrating exemplary system architecture according to the present invention.

FIG. 3 is a functional diagram block illustrating the business process.

FIG. 4 is a logical process diagram block illustrating exemplary system architecture according to the present invention.

### DETAILED DESCRIPTION OF EXEMPLARY EMBODIMENTS

The present invention provides a solution for people to watch new released movies online synchronizing with the new released movies shown in the cinemas. Customers are required to have accounts to buy the ticket(s) and watch the new movies. Although the preferred embodiment will be generally described in the context of a program and an operating system running on a personal computer, those skilled in the art will recognize that the present invention also can be implemented in conjunction with other program modules for other types of computers. Furthermore, those skilled in the art will recognize that the present invention may be implemented in different network environments.

For example, in a two-tier network, a customer communicates directly with a server. This is also known as a client-server architecture. A client-server network is an architecture that involves user processes that request service from server processes. The customer and the server communicate over a network using a given protocol, which must be installed on both the customer and the server. In an N-tier architecture, the role of the middle-tier agent can be manifold. It can provide: translation services (as in adapting a legacy application on a mainframe to a user-server environment or acting as a bridge between protocols); scalability services (as in acting as a transaction-processing monitor to balance the load of requests between servers); intelligent agent services (as in mapping a request to a number of different servers, collating the results, and returning a single response to a user). In a complex network environment, different hardware platforms run different operating systems; multiple protocols are used on these platforms; variable syntax exist between the different but connected applications; run on different geographical locations in which the connected applications reside. It supports a large-scale distributed system.

In a distributed computing environment, program modules may be physically located in different local and remote memory storage devices. Execution of the program modules many occur locally in a stand-alone manner or remotely in a customer server manner. Examples of such distributed computing environments include local area networks of an office, enterprise-wide computer networks and the global interne.

The detailed description which follows is represented largely in terms of processes and symbolic representations of operations by conventional computer components, including a central processing unit (CPU), memory storage devices for the CPU, display devices, and input devices. Furthermore, these processes and operations may utilize conventional computer components in a heterogeneous distributed computing environment, including remote file servers, remote computer servers, and remote memory storage devices. Each of these conventional distributed computing components is accessible by the CPU via a communication network.

The processes and operations performed by the computer include the manipulation of signals by a CPU or remote server and the maintenance of these signals within data structures resident in one or more of the local or remote memory storage devices.

For the purpose of this discussion, a process is generally conceived to be a sequence of computer-executed steps leading to a desired result. These steps usually require physical manipulation of physical quantities. Usually, though not necessarily, these quantities take the form of electrical, magnetic, or optical signals capable of being stored, transferred, combined, compared, or otherwise manipulated. It is convention for those skilled in the art to refer to representation of these signals as bits, bytes, words, information, elements, symbols, characters, numbers, points, data, entries, objects, images, files, or the like. It should be kept in mind, however, that these and similar terms are associated with appropriate physical quantities for computer operations, and that these terms are merely conventional labels applied to physical quantities that exist within and during operation of the computer

It should be understood that manipulations within the computer are often referred to in terms such as creating, adding, changing, modifying, saving, calculating, comparing, moving, receiving, determining, identifying, populating, loading, executing, etc. that are often associated with manual operations performed by a human operator. The operations described herein can be machine operations performed in conjunction with various input provided by a human operator or user that interacts with the computer.

In addition, it should be understood that the programs, processes, methods, etc. described herein are not related or limited to any particular computer or apparatus. Rather various types of general purpose machines may be used with the program modules constructed in accordance with the teachings described herein. Similarly, it may prove advantageous to construct a specialized apparatus to perform the method steps described herein by the way of dedicated computer systems in specific network architecture with hardwired logic or programs stored in nonvolatile memory, such as ready-only memory. Such data structures impose a physical organization upon the collection of data stored within a memory storage device and represent specific electrical or magnetic elements. These symbolic representations are the means used by those skilled in the art of computer programming and computer construction to most effectively convey teachings and discoveries to other skilled in the art.

Referring now to the drawings, in which like numerals represent like elements throughout the Figures, aspects of the present invention and the illustrative operating environment will be described.

### Model 1

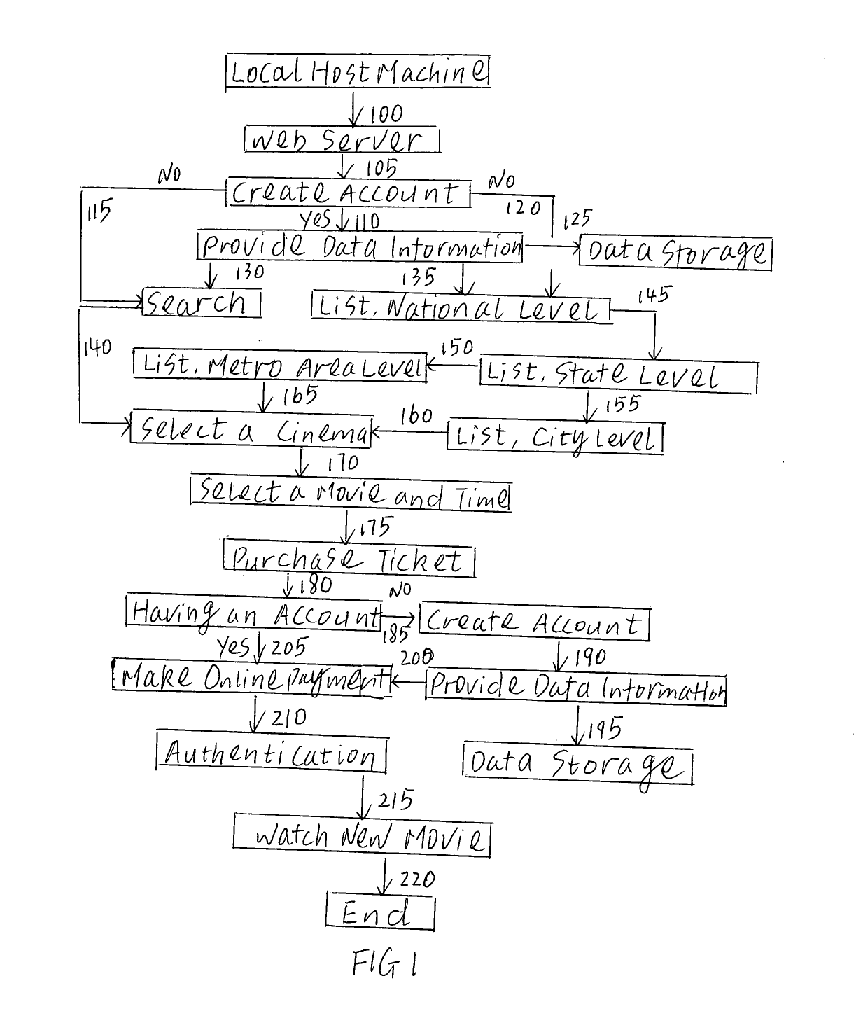

Refer now to FIG. 1, this figure is a functional block diagram illustrating how the business process flows.

The local customer connects to the internet and access to the website (Step 100). The connection is a communication pathway between a user process and a server process. The user logs on to the operating system on a local computer and connects over a network to the computer running web applications. The user originates the request. A process is created on the client. The process is called user process. The server listens, receives, parses and executes the request sent from the user process. This process is called a server process. The process communicates with the server on behalf of the user process. The server process executes the request. After the process finishes, the returned result is sent back to the user.

The web application displays the graphic interface which is the first page of the website. The interface is made up of items. Items are used to present information from the database or to act as control. The web application is event-driven. An event occurs and the application responds to it. An event is either an interface event, which corresponds to a user action, or an internal processing event, which corresponds to a system action.

In the middle there is a virtual 3D simulation cinema graphic image. Under the image, there are small flashing navigation arrow tabs. If they are clicked, it will go to the next page. The function is designed for the customer to find a cinema by walking through the web pages.

On the upper right side of the first page there are two tabs: Create Account and Search. Create Account is for storing the customers' information, to buy ticket and watch a movie (Step 105). If the customer chooses to create an account, he or she is required to provide data information (Step 110). If the customer chooses not to create an account, he or she can go directly go to select a cinema through searching or from the list (Step 115 and Step 120), and create an account later.

After the information is provided, the account is created. The account information is saved on the server (Step 125).

The customer can either choose to select a cinema through searching or from the list. If the customer chooses to search (Step 130), the data needs to be provided in order to run criteria. There are two designs. The first design is blank search, meaning the customer can type anything such as a state, a metro area or a city. The second design is providing category. A). If state is the search target, all the cities in the state are listed at the bottom of the screen alphabetically from left to right. In the middle the cinema with the first alphabetical letter of the first city is set as default in the middle of the page. Clicking any city at the bottom will show all the cinemas listed at the bottom alphabetically from left to right in that city. The cinema with the first alphabetical letter is set as default in the middle of the screen. B). If metro area is the search target, the metro areas of the state are listed at the bottom of the page alphabetically from left to right. In the middle the cinema with the first alphabetical letter of the first metro area is set as default in the middle of the page. Clicking any metro area will show all the cinemas listed at the bottom of the page. The cinema with the first alphabetical letter is set as default in the middle of the page. Clicking any cinema will go to that cinema. C). If city is the search target, the cinemas in the city will be listed at the bottom of the page alphabetically from left to right. The cinema with the first alphabetical letter is set as default in the middle of the screen. Clicking any cinema will go to that cinema's front page.

State, metro area and city these three categories will be put under the search for the second design. The customer selects one of them and enters the criteria to search. When the search finishes, the result is displayed. The result refers to a specific area or a cinema that the customer is looking for (Step 140).

If the customer chooses to go through the web pages to find a cinema, he or she takes the step 135 where the states will be listed on the second page (Page 2, Interface 2). There are 50 states listed in the middle of the screen on the page. On the top and at the bottom parts there are video and image spots for advertisement.

Clicking one of the states goes to the next page (Page 3, interface 3). This is the step 145. On page 3 the cities in the state are listed in the middle of the screen. On the top and at the bottom parts there are video and image spots for advertisement. At the right bottom part above the advertising spots there is a tab link to the metro areas.

Clicking the Metro Area tab goes to the metro area level in the state (Step 150, page 4, interface 4). All the metro areas are put at the bottom of the page alphabetically from left to right. In the middle the cinema with the first alphabetical letter is set as default. Clicking any metro area at the bottom will go to that metro area with all the cinemas listed at the bottom. Clicking any cinema at the bottom will go to that cinema's front page (Step 165).

Clicking one of the cities on Page 3 goes to the next page (Page 5, interface 5). This is the step 155. On page 5 there are cinemas listed at the bottom of the screen alphabetically from left to right. In the middle the cinema with the first alphabetical letter is set as default. Clicking any cinema at the bottom will go to that cinema's front page (Step 160).

Clicking the picture of the cinema or the tab of the arrow goes to Page 6, interface 6. On the top of the page 6 it shows the box office area. There are movie posters under it with prices, movie showtimes etc.

The customer selects a movie, how many people to watch, movie showtime and purchases the ticket(s) (Step 170 and 175). When purchasing the ticket(s), the customer is asked whether he or she has an account (Step 180). If the customer doesn't have an account, he or she needs to create one (Step 185). During establishing the account, he or she needs to provide data information (Step 190). After the data information is provided, the account is created and the data information is saved in the data file on the server (Step 195). The customer buy the ticket(s) and make payment online (Step 200). If the customer has an account, the customer purchases the ticket(s) (Step 205). After the payment is made online, it is ready to watch a movie after authentication (Step 210). During the authentication process, a java function is invoked. It provides a default verification routine to verify the validity of the data. The procedure returns the value TRUE for success and FALSE for failure. If the verification raises an exception, the data becomes invalid, an error is returned. The process goes back until the data provided is good and valid.

After the verification is done, the customer will be led to the lounge where the movie will be shown. The customer will have virtual 3D cinema environment experience as going to the real cinema. Each new movie on shown will be displayed at the lounge. The customer can only access to the new movie he or she buys the ticket to watch the new movie (Step 215).

The time to watch a new released movie online is exactly the same time that is shown in the cinema. They synchronize. The process ends when the movie is over (Step 220).

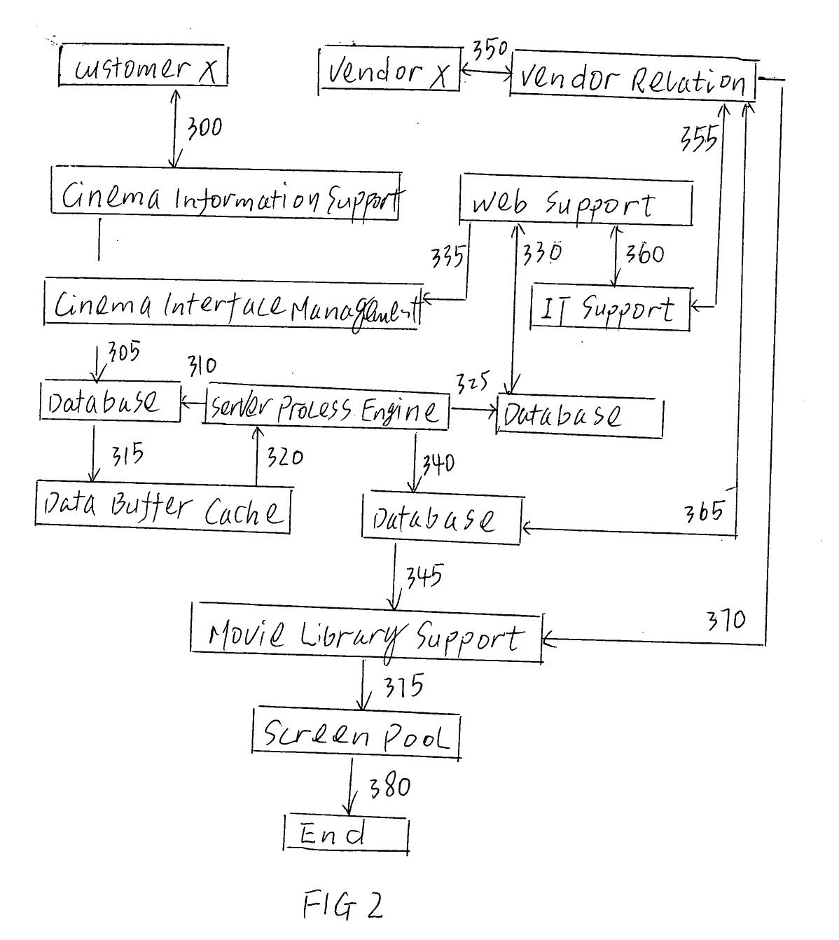

Refer to FIG. 2. FIG. 2 is a functional diagram block illustrating exemplary system architecture according to the present invention. The exemplary system architecture comprises a computer system, software and a web application with databases. The computer system consists of a stand-alone user local machine and a computer server. The web applications with databases are stored on the hard disk within the computer server. The computer system is operated within networks and interne.

There are 5942 cinemas in the U.S. and everyday there are people who will possibly watch new movies in any cinema; the customer can watch any new movie online anywhere; the customer needs to have an account to buy ticket(s) and watch new movies; the customer will buy tickets using online payment method; the customer will get support if there is something wrong; the cinema movie time schedules need to be checked and updated accurately if necessary; the sales needs to be collected and distributed accurately.

In order to meet the above business requirements, the technical requirements need to be specified. The hardware, software, database design, application forms, data, schema objects, machine power and capacity to support running and backups, recreated data, reload the data to the database from a flat file, database configuration support resiliency to different types of failures, disaster recovery solutions, manpower and time are just some of the examples.

The platform is made up of servers, OS, softwares, databases, interne and network including hardware. Besides, it will be supported by several groups. These groups are cinema information support group, web support group, vendor relation support group, movie library support group and IT support group.

Step 300 is the step that the cinema information support group coordinates with Customer X and gets all the information. Customer X refers to number of X customers (Cinema companies) whom the information support group will deal with. The information is the information related to the new released movies and the movie showtimes schedule. X numbers of customers are divided by ten different regions in the country so that they can be easily managed.

After the information is collected, it will be put into the Master Schedule Sheet in each region (Step 305). The Master Schedule Sheet is a form developed by IT support group. The Master Schedule Sheets are stored in the data files on the server. The Master Schedule Sheets contain information such as cinema ID, movie name, date, cinema name, parent company, producers, the new released movies and movie showtimes etc.

The server process engine is scheduled to look the Master Schedule Sheets and query (Step 310). The server process engine is made up of many different procedure packages. These packages are stored on the disc. Once they are called, they will perform the activities as programmed. The server process looks in the database buffer cache for any blocks it needs. The size is determined by the block size. If the block is not found in the database buffer cache, the server process reads the block from the data file and places a copy in the buffer cache (Step 315). The server uses a least recently used algorithm to age out buffers that have not been accessed recently to make room for new blocks in the database buffer. If the query is successful, it returns data as result (Step 320). There are four main stages in the process A). Initiating and parsing, during the stage, the request statement is passed, and a parsed representation of the request is loaded on the server. During the parse, the server process searches for the existing request copy; validates the request by checking its syntax; performs data dictionary lookups to validate file definitions; acquires parse locks on the object so that the definition doesn't change during the parsing of the request; determines the optimal execution plan for the request; loads the request and execution plan into the buffer cache and send back to the server for processing. The initiate and parse stage includes processing the requirement that needs to be done only once. The server process engine usually translates each requirement only once, re-executing that parsed during subsequent references to the request. Although parsing requirement validates that require, parsing only identifies errors that can be found before requirement execution. B). Executing the requirement, at this point, the server has all the resources and necessary information, so the requirement is executed, the server process prepares to retrieve the data. C). Fetching, in the fetching stage, the data is collected and returned to the data blocks designed for further process. D). Saving, during saving all the fetched data is saved in the data files on the server (Step 325). Ten fetches are required to transfer the results of the query. More are needed if the data results are not complete and satisfactory.

Query can be for different purposes. There are two major queries involved for getting two different batches of data results. The first batch data result is designed and used for supporting the cinema GUI interface management module. As having been discussed, there are ten fetches. These ten fetches will generate the detailed daily updated forecast information report for every cinema in the country. The updated information report has information regarding whether there are new movies starting to be shown each day. All the data are saved and stored accordingly in different files in different databases on the server.

There are hundreds of databases. The databases of the schedules for the new released movies for very cinema are divided into 10 by region.

The database is a collection of data. The database structure includes logical and physical structures that make up the database. The physical structure includes all the files such as control files, data files and redoes log files that make up the database. The logical structure includes tablespaces, segments, extents, and data blocks. The server enables fine-grained control of disk space use through tablespace and logical storage structures, including segments, extents, and the data blocks. The data in the database are stored in the tablespaces. The tablespaces are grouped into smaller logical areas for the database. A tablespace belongs to only one database at a time. Each tablespace consists of one or more operating system files, which are called data files. The tablespace consists of one or more segments. It can be brought online when the database is running. The Segment is the space allocated for a specific logical storage structure within a tablespace. The segment cannot span tablespaces; however, the segment can span multiple data files that belong to the same tablespace. The segment is made up of one or more extents. Space is allocated to the segment by extents. As the segment grows, extents are added to the segment. The extent is a set of contiguous blocks. The extent cannot span a data file, but must exist in the datafile.

A data file can belong to only one tablespace. It is created on the tablespace by allocating the specified amount of disk space plus a small amount of overhead. The data blocks are the smallest units of storage that can be can read, allocated and written. The data block responds to one or more operating system blocks allocated from the existing data file.

The purpose of a database is to store and retrieve related information. The database consists of A). Data files. Data files contain the actual data in the database. The data is stored in user-defined tables, but data files also contain the data dictionary, before-images of modified data, index, and other types of structures. The data files have certain characteristics set to allow them automatically extend when the database runs out of space. B). Redo log files. Redo logs contain a record of changes made to the database to enable recovery of the data in case of failures. C). Control files. Control files contain information necessary to maintain and verify database integrity.

The cinema GUI interface management is responsible for updating the data for every cinema in the country everyday. It can be changed automatically through programming or manually updated by the web support group.

Programs are hard codes stored as units on the server. They are called program units. They are a logically related set of language statements that perform a specific task. They are called by triggering. They can be procedures, functions, triggers, or packages and are created and stored in the data dictionary as a schema object.

The stored procedure is a procedure or function. It consists of a set of java constructs. Procedures and functions are identical except that functions always return a single value to the caller, while the procedures do not. The trigger is a java program unit that is executed implicitly by the server when a specific type of event occurs. The trigger is never called; it only executes when the event occurs. A package is a group of functionally related variables, constrains, cursors, exceptions, procedures, and functions stored together in the database as a unit. Packaged procedures and functions can be called explicitly by the applications or users. The package usually has two parts stored separately in the database: A). The specification is the interface to the application and declares the types, variables, constraints, exceptions, cursors, and sub programs available for use outside of the package; B). The body implements the specification. It includes the java code to implement the procedure and function specification included in the package specification. It may also include procedures and functions that are callable only from inside of the package. The functionality of a package is similar to that of stored procedures. Once written and compiled, the contents can be shared by many applications.

If the cinema GUI interface automatically updates, the scheduled programming procedure will be initiated and launched. If the cinema GUI interface needs to be manually updated, the web support group will check the updated information in the database and manually update the information of every cinema (Step 330 and Step 335). The information contains all the information related to the cinemas, new movies such as movie name, movie time and price etc.

The second batch data result is designed and used for supporting the screen pool management module. There is only one fetch. More are needed if the data results are not complete or satisfactory. It will run all the Master Forecast Sheets in different databases. It will generate a detailed daily updated information report (Step 340). The information report will report which new movies will be put online at what movie times and which movies will be taken offline. The new data will be saved in the file on the server. The movie library support checks the report (Step 345) and has the contents ready from the vendor group.

The vendor relation group interacts with Vendor X (Step 350). Vendor X refers to X number of vendors (Studios) that the vendor relation support group deals with. The vendor relation support group looks in the tablespace of the database for new movie time schedules (Step 365). After it is done, they coordinate with the vendors and get all the materials they need and pass them to the IT support group (Step 355) and the movie library support group (Step 370).

The IT support group checks the same report as the movie library support does and get promotional materials from the vendor support group. The IT support group will develop posters and pass them to the web support group (Step 360). Other IT support group duties will be maintain the website and databases, system set up, product development, network configuration, monitoring, administration; configuration, backup, and tuning etc.

The movie library support group checks the report in the database and uploads the contents in the screen pool and configures (Step 375). The screen pool is used to allocate sequential I/O buffers from memory for the purpose of providing the dedicated ip or link addresses that will link to the screens where all the new movies will be shown. The same new film will be shown on different screens if the movie has different showtimes. The IP or link addresses to the screens won't change until the movie won't be shown in any cinema. This scenario applies to all the new movies. If the movie won't show anymore, the IP or link addresses will be released.

The library contains all the new released movies. The new released movie copies depends on how many times the new movie are scheduled to be shown. Each new movie has approximately 50 to 60 copies.

When movie time is up, the screen will begin to show the new movie. The contents are the contents related to the movie and advertisement if there is any. The process ends at the new movie no longer shows and it is taken offline (Step 380).

### Model 2

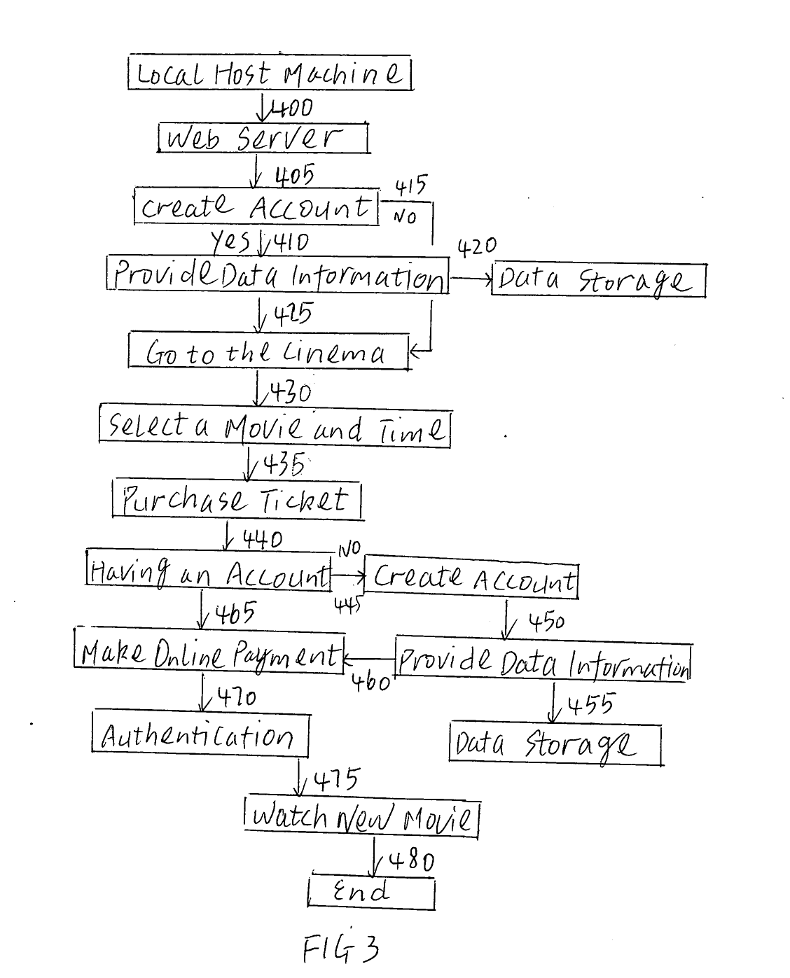

Refer to FIG. 3, this is a process functional diagram block illustrating how the business process flows for the second model.

The local customer connects to the interne and access to the website (Step 400). The connection is a communication pathway between a user process and a server process. The user logs on to the operating system on a local computer and connects over a network to the computer running web applications. The user originates the request. A process is created on the client. The process is called user process. The server listens, receives, parses and executes the request sent from the user process. This process is called a server process. The process communicates with the server on behalf of the user process. The server process executes the request. After the process finishes, the returned result is sent back to the user.

The web application displays the graphic interface which is the first page of the website. The interface is made up of items. Items are used to present information from the database or to act as control. The web application is event-driven. An event occurs and the application responds to it. An event is either an interface event, which corresponds to a user action, or an internal processing event, which corresponds to a system action.

In the middle there is a virtual 3D simulation cinema graphic image. Under the image, there are small flashing navigation arrow tabs. If they are clicked, it will go to the next page. This function is designed for the customer to find a cinema walking through web pages.

On the upper right side of the page there is a Create Account tab. Create Account is for storing the customers' information, buy ticket and watch a movie. If the customer chooses to create an account (Step 405), he or she is required to provide data information (Step 410). After the data information is provided, it is stored in the data file on the server (Step 420). If the customer chooses not to create an account, he or she can go directly to the cinema (Step 425). Step 430 is the step that the customer chooses a movie and movie time, and purchase ticket (Step 435).

The customer is asked whether he or she has an account (Step 440). If he or she doesn't have one, the customer is asked to create an account (Step 445) and provide data information (Step 450). The data information will be saved in the data file on the server (Step 455). The customer can purchase ticket and make online payment (Step 460). If the customer has an account, he or she can purchase ticket and make online payment (Step 465). Authentication is required in order to watch new movie (Step 470). After the authentication is done, the customer is ready to watch a new movie (Step 475). The process ends when the new movie is over (Step 480).

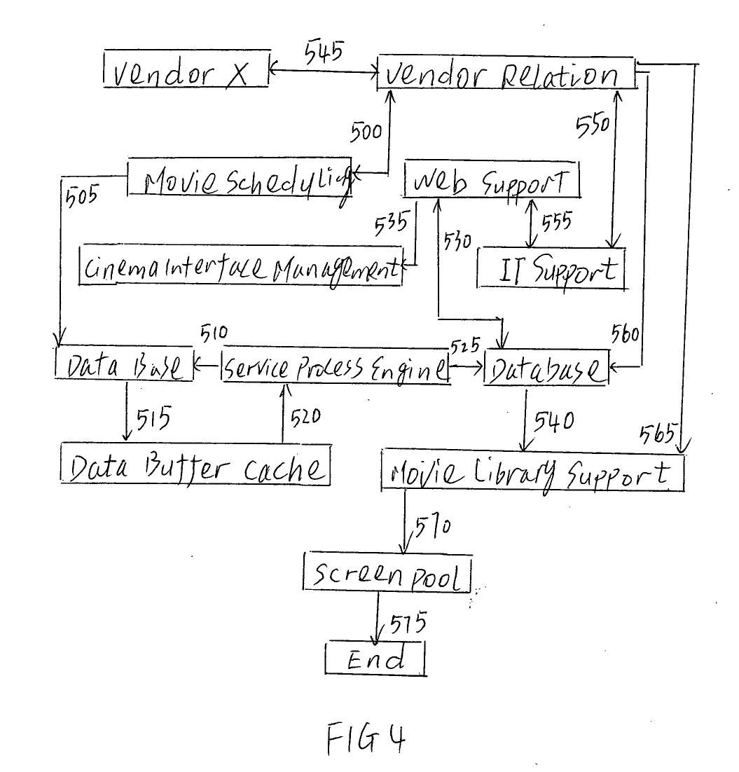

Refer to FIG. 4, this is a logical diagram block illustrating exemplary system architecture according to the present invention. The exemplary system architecture comprises a computer system, software and a web application with databases. The computer system consists of a stand-alone user local machine and a computer server. The web applications with databases are stored on the hard disk within the computer server. The computer system is operated within networks and internet.

The platform of the second model is made up of servers, OS, softwares, databases, internet and network including hardware. Besides, it will be supported by several groups. These groups are movie schedule group, web support group, vendor relation group, movie library support group and IT support group.

Step 500 is the step that the movie schedule group coordinates with the vendor relation group and gets all the information. The information includes all the information regarding the new released movies on the market. After the information is collected, the schedule group prepares for the movie showtimes schedule and put the data into the Master Schedule Sheet (Step 505). The Master Schedule Sheet is a form developed by IT support group. The Master Schedule Sheet is stored in the data file on the server. The Master Schedule Sheet contains information such as move names, date when they are going to be shown and taken offline, producers and showtimes schedule etc.

The server process engine is scheduled to look the Master Schedule Sheet and query (Step 510). The server process engine is made up of many different procedure packages. These packages are stored on the disc. Once they are called, they will perform the activities as programmed. The server process looks in the database buffer cache for any blocks it needs. The size is determined by the block size. If the block is not found in the database buffer cache, the server process reads the block from the data file and places a copy in the buffer cache (Step 515). The server uses a least recently used algorithm to age out buffers that have not been accessed recently to make room for new blocks in the database buffer. If the query is successful, it returns data as result (Step 520). There are four main stages in the process A). Initiating and parsing, during the stage, the request statement is passed, and a parsed representation of the request is loaded on the server. During the parse, the server process searches for the existing request copy; validates the request by checking its syntax; performs data dictionary lookups to validate file definitions; acquires parse locks on the object so that the definition doesn't change during the parsing of the request; determines the optimal execution plan for the request; loads the request and execution plan into the buffer cache and send back to the server for processing. The initiate and parse stage includes processing the requirement that needs to be done only once. The server process engine usually translates each requirement only once, re-executing that parsed during subsequent references to the request. Although parsing requirement validates that require, parsing only identifies errors that can be found before requirement execution. B). Executing the requirement, at this point, the server has all the resources and necessary information, so the requirement is executed, the server process prepares to retrieve the data. C). Fetching, in the fetching stage, the data is collected and returned to the data blocks designed for further process. D). Saving, during saving the fetched data is saved in the data files on the server. One fetch is required to transfer the results of the query. More are needed if the data results are not complete and satisfactory.

The batch data result from query is designed and used for supporting the cinema GUI interface management module. The fetch will generate the detailed daily forecast information report for the cinema. The forecast information report has information regarding whether there are new movies starting to be shown on the day of the month. All the forecast data information is saved and stored in the database on the serve (Step 525).

The database is a collection of data. The database structure includes logical and physical structures that make up the database. The physical structure includes all the files such as control files, data files and redoes log files that make up the database. The logical structure includes tablespaces, segments, extents, and data blocks. The server enables fine-grained control of disk space use through tablespace and logical storage structures, including segments, extents, and the data blocks. The data in the database are stored in the tablespaces. The tablespaces are grouped into smaller logical areas for the database. A tablespace belongs to only one database at a time. Each tablespace consists of one or more operating system files, which are called data files. The tablespace consists of one or more segments. It can be brought online when the database is running. The Segment is the space allocated for a specific logical storage structure within a tablespace. The segment cannot span tablespaces; however, the segment can span multiple data files that belong to the same tablespace. The segment is made up of one or more extents. Space is allocated to the segment by extents. As the segment grows, extents are added to the segment. The extent is a set of contiguous blocks. The extent cannot span a data file, but must exist in the datafile.

A data file can belong to only one tablespace. It is created on the tablespace by allocating the specified amount of disk space plus a small amount of overhead. The data blocks are the smallest units of storage that can be can read, allocated and written. The data block responds to one or more operating system blocks allocated from the existing data file.

The purpose of a database is to store and retrieve related information. The database consists of A). Data files. Data files contain the actual data in the database. The data is stored in user-defined tables, but data files also contain the data dictionary, before-images of modified data, index, and other types of structures. The data files have certain characteristics set to allow them automatically extend when the database runs out of space. B). Redo log files. Redo logs contain a record of changes made to the database to enable recovery of the data in case of failures. C). Control files. Control files contain information necessary to maintain and verify database integrity.

The cinema GUI interface management is responsible for updating the information for the cinema everyday. It can be changed automatically through programming or manually updated by the web support group.

Programs are hard codes stored as units on the server. They are called program units. They are a logically related set of language statements that perform a specific task. They are called by triggering. They can be procedures, functions, triggers, or packages and are created and stored in the data dictionary as a schema object.

The stored procedure is a procedure or function. It consists of a set of java constructs. Procedures and functions are identical except that functions always return a single value to the caller, while the procedures do not. The trigger is a java program unit that is executed implicitly by the server when a specific type of event occurs. The trigger is never called; it only executes when the event occurs. A package is a group of functionally related variables, constrains, cursors, exceptions, procedures, and functions stored together in the database as a unit. Packaged procedures and functions can be called explicitly by the applications or users. The package usually has two parts stored separately in the database: A). The specification is the interface to the application and declares the types, variables, constraints, exceptions, cursors, and sub programs available for use outside of the package; B). The body implements the specification. It includes the java code to implement the procedure and function specification included in the package specification. It may also include procedures and functions that are callable only from inside of the package. The functionality of a package is similar to that of stored procedures. Once written and compiled, the contents can be shared by many applications.

If the cinema GUI interface automatically updates, the scheduled programming procedure will be initiated and launched. If the cinema GUI interface needs to be manually updated, the web support group will check the forecast information in the database and manually update the information (Step 530 and Step 535). The information contains all the information of the new movies and schedule movie times etc.

The movie library support checks the report (Step 540) and has the contents ready from the vendor group. The vendor relation group interacts with Vendor X (Step 545). Vendor X refers to X number of vendors (Studios) that the vendor relation group deals with. The vendor relation group looks in the tablespace of the database for new movie time schedule (Step 560). After it is done, they coordinate with the vendors and get all the materials they need and pass them to the IT support group (Step 550) and the movie library support group (Step 565).

The IT support group checks the same report as the movie library support does and get promotional materials from the vendor support group. The IT support group will develop posters and pass them to the web support group (Step 555). Other IT support group duties will be maintain the website and databases, system set up, product development, network configuration, monitoring, administration; configuration, backup, and tuning etc.

The movie library support group check the report in the database and upload the contents in the screen pool and configure (Step 570). The screen pool is used to allocate sequential I/O buffers from memory for the purpose of providing the dedicated ip or link addresses that will link to the screens where all the new movies will be shown. The same new film will be shown on different screens if the movie has different showtimes schedule. The IP or link addresses to the screens won't change until the movie won't be shown. This scenario applies to all the new movies. If the movie won't show anymore, the IP or link addresses will be released.

The library contains all the new released movies. The new released movie copies depends on how many times the new movie are scheduled to be shown. Each new movie has approximately 10 to 20 copies.

When movie time is up, the screen will begin to show the new movie. The contents are the contents related to the movie and advertisement if there is any. The process ends at the new movie no longer shows and it is taken offline (Step 575).

1. Watch new released movies online synchronizing with new released movies shown in cinemas
